(19) United States
(12) Patent Application Publication
(10) Pub. No.: US 2007/0217184 A1
(43) Pub. Date: Sep. 20, 2007

(54) LED light assembly

(76) Inventor: James Berry, Pittsford, NY (US)

Correspondence Address: LAW OFFICE OF TRACY P. JONG, 2775 BUFFALO ROAD, SUITE 3, RORCHESTER, NY, 14514, US

(21) Appl. No.: 11/716,103

(22) Filed: Mar. 10, 2007

Related U.S. Application Data
(60) Provisional application No. 60/782,954, filed on Mar. 16, 2006.

(51) Int. Cl. F21V 21/084; F21V 23/04

(52) U.S. Cl. 362/105; 362/251; 362/394

(57) ABSTRACT

A LED light assembly comprising a pivotal means of fastening, a plurality of LED light devices, and a housing adapted to be removably attached to a front piece holder of a traditional fire helmet. The means of selectively engaging LED lights comprises said front piece holder contacting a contact point on the switch of each LED light device, causing them to depress and actuate a mechanism that causes the LED bulbs to light.

### PRIORITY

This application claims the benefit of a provisional application U.S. Ser. No. 60/782,954 filed in then name of James Berry on Mar. 16, 2006.

### FIELD OF THE INVENTION

This invention generally relates to devices for emitting light and more particularly, to safety devices for fire helmets.

### BACKGROUND OF THE INVENTION

Firefighters and rescue personnel often are required to enter smoke-filled rooms where visibility is poor but essential to a proper performance of their duties. Poor visibility in smoke-filled environments interferes with the ability to locate victims, avoid dangerous obstructions in the path of travel, and coordinate rescue and fire efforts with co-workers. Similar challenges are encountered in areas filled with steam, dust or fog.

Most prior art lighting devices emit light that reflects off smoke particles, scattering the light in many directions. Thus, the light's penetrating power is limited. These properties of the traditional light emitting devices (such as incandescent and halogen bulbs) render them poorly suited to these applications involving conditions of smoke, dust and fog. Additional limitations include the fragility of the bulbs and their tendency to break when the devices are dropped or rattled, weak light emission from weak batteries, and poor reliability under harsh rescue of fire conditions with high temperatures and excessive water contact.

Hands-free operable devices are especially desirable for firefighters and rescue workers who are generally clothed with protective gear and heavy gloves that make it difficult to operate buttons requiring precision or fine motor skills. Additionally, obviating the necessity of carrying a device in the hands, thereby freeing the hands, enhances the ability to perform essential tasks.

While the practical utility of safety lights and flashlights are generally known, none of the existing devices are entirely satisfactory in addressing these issues. Published patent application US 2003/0179570 A1 (multi-purpose LED light) to Schell discloses and claims a LED light device adaptable for removable mounting to a visor or brim. However, said device may not be suitably used on a fire helmet for several reasons. First, the materials from which the device is comprised would not withstand the thermal impact of direct exposure to inflagrations. Second, the clip mechanism is not well-suited to attach a LED to a fire helmet. The clip would not attach to the top of the fire helmet as desirable, and even if it was managed, would not direct the light forward. Thirdly, the means of operating the light is limited. With the bulky fire protective gloves, a firefighter would be forced to turn on the light prior to clipping the LED light device on his helmet and entering the fire. Thus, he would not have a means of selectively turning the bulb on and off on an as-needed basis. This would unnecessarily usurp battery power and may require frequent maintenance and battery replacement.

There is needed an improved device for emitting light that can be removably attached to fire helmets and other safety hats for hands free operation under low visibility conditions such as smoke, dust and fog filled spaces. The present invention fulfills this need.

### SUMMARY OF THE INVENTION

In accordance with this invention, and in one embodiment thereof, there is provided a LED light assembly comprising a housing adapted to be removably attached to a helmet or protective headgear, at least one LED light device, wherein said LED light device comprises a switch, wherein said switch controls said LED light device, said LED light device is engaged to said housing, and a means of actuating said switch.

In one embodiment, the LED light assembly comprises a housing adapted to be removably attached to a front piece holder of a traditional fire helmet, a first LED light device, wherein said first LED light device comprises a first switch and a first LED bulb, said first LED light device is engaged to said housing, and a means of actuating said first switch thereby causing said first LED bulb to illuminate.

In one embodiment, the LED light assembly comprises a pivotal means of fastening, a plurality of LED light devices, and a housing adapted to be removably attached to a front piece holder of a traditional fire helmet comprising a front piece holder, wherein a first LED light device comprises a switch, a first LED bulb and a first contact point, wherein a second LED light device comprises a switch, a second LED bulb and a second contact point, wherein said front piece holder contacts said first and said second contact points, it causes them to depress and actuate a mechanism that causes said first and said second LED bulbs to light.

Accordingly, it is an object of the present invention to provide an improved light assembly that may be removably attached to a fire helmet, safety hat or other device.

It is an object of the present invention to provide a LED light assembly that can be engaged and disengaged while wearing safety gloves.

It is an object of the present invention to provide a LED light assembly that can emit light that enables a person to see said light at a distance of more than one foot away in a smoke-filled room.

It is an object of the present invention to provide a LED light assembly that is durable and reliable.

It is an object of the present invention to provide a LED light assembly that is portable and may be moved from one fire helmet or safety hat to another.

It is yet another object of this invention to provide a relatively simple LED light assembly that is economical from the viewpoint of the manufacturer and consumer, is susceptible of low manufacturing costs with regard to labor and materials, and which accordingly is then susceptible of low prices for the consuming public, thereby making it economically available to the buying public.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of the claims appended to this specification.

In this respect, before explaining at least one embodiment of the invention in detail, it is to be understood that the invention is not limited in its application to the details of construction and the arrangements of the components set forth in the following description or illustrated in the drawings. The present invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent construction insofar as they do not depart from the spirit and scope of the conception regarded as the present invention.

### BRIEF DESCRIPTION OF THE DRAWINGS

The invention will be described by reference to the specification and the drawings, in which like numerals refer to like elements, and wherein:

FIG. 1 is a front perspective view of a LED light assembly mounted on a traditional fire helmet in the engaged position;

FIG. 2 is a front perspective view of a LED light assembly mounted on a traditional fire helmet in the disengaged position;

FIG. 3 is a front perspective view of a traditional fire helmet;

FIG. 4 is a front perspective view of a LED light assembly;

FIG. 5A is a side view of a LED light assembly mounted on a front piece holder;

FIG. 5B is another side view of a LED light assembly mounted on a front piece holder as depicted in FIG. 5A;

FIG. 6A is a front sectional view of a LED light assembly;

FIG. 6B is a front sectional view of a housing of a LED light assembly as depicted in FIG. 6A;

FIG. 6C is a plan view of a LED light assembly as depicted in FIG. 6A;

FIG. 7A is a side view of a LED light device as depicted in FIG. 4;

FIG. 7B is a plan view of a LED light device as depicted in FIG. 7A;

FIG. 8 is a perspective view a LED light device as depicted in FIG. 4 and how to assembly same; and

FIG. 9 a front perspective view of a LED light assembly mounted on a front piece holder of a traditional fire helmet in the disengaged position.

### DETAILED DESCRIPTION OF PREFERRED EMBODIMENTS

In accordance with this invention, there is provided a LED light assembly which may be readily attached to any conventional fire helmet to provide a convenient means of emitting light to enable a person to visibly detect said light at a distance of more than one foot away in a smoke-filled room. The LED light assembly comprises a housing adapted to be removably attached to a helmet or protective headgear, at least one LED light device, wherein said LED light device comprises a switch, wherein said switch controls said LED light device, said LED light device is engaged to said housing, and a means of actuating said switch.

In one embodiment the LED light assembly comprises a housing adapted to be removably attached to a front piece holder of a traditional fire helmet, a first LED light device, wherein said first LED light device comprises a first switch and a first LED bulb, said first LED light device is engaged to said housing, and a means of actuating said first switch thereby causing said first LED bulb to illuminate.

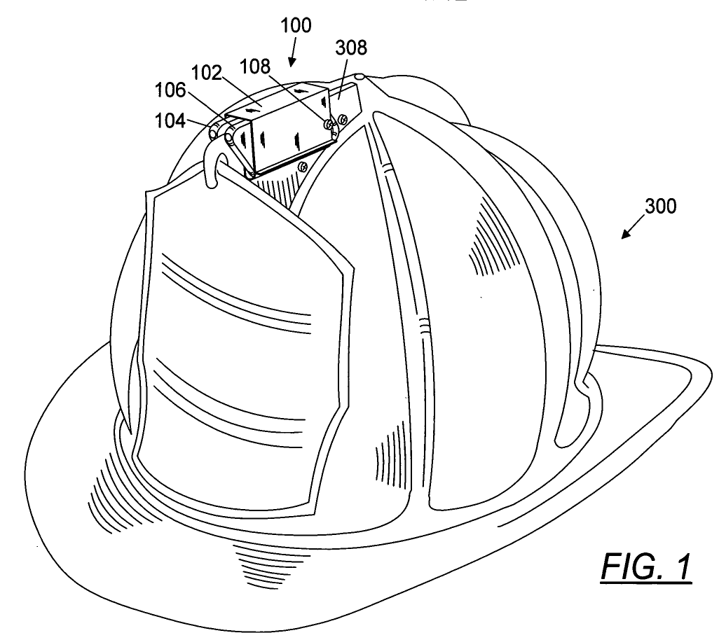

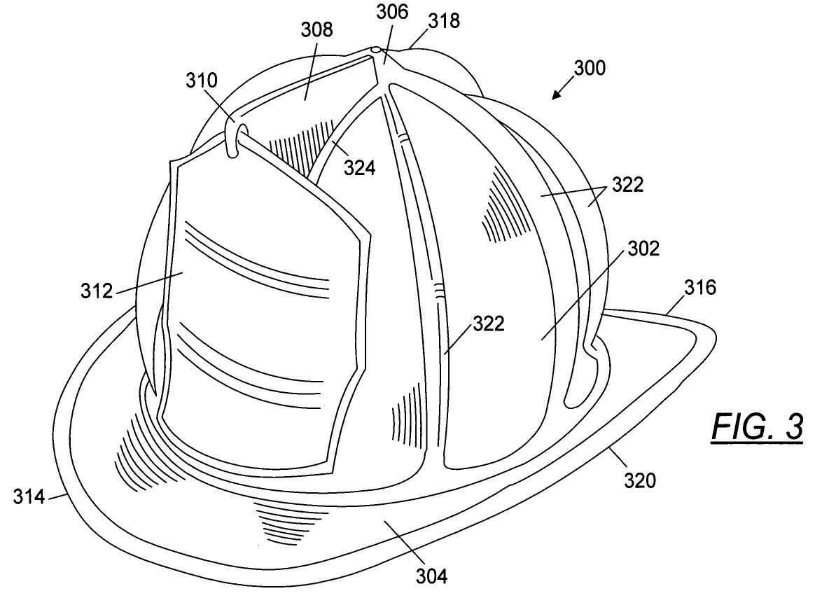

Referring to FIG. 1, a LED light assembly 100 comprises a housing 102, a pivotable means of fastening 108 and a plurality of LED light devices 104, 106. As shown, LED light assembly 100 is adapted to be removably attached to a brass front piece holder 308 of a traditional fire helmet 300. Reference is made to FIG. 3 depicting a traditional style fire helmet and the accompanying description.

By way of example, LED light assembly is described herein and depicted herein via an application where it is mounted on a traditional fire helmet for use and where the LED lights are forward facing. It is to be understood that LED light assembly may be suitably mounted on other designs of fire helmets, as well as other protective headgear (e.g. mining hats, construction hats, safety hats, and the like). LED light assembly may also be mounted on other gear worn or used by a user without departing from the scope of the invention. Also within the scope of the present inventions are LED light assemblies comprising both forward and rearward facing LED lights or 4 LED lights disposed every 90 degrees about a circle to reflect forward, rearward and sideways. Features such as continuously rotating lights or manually focusable and directed LED lights are also considered within the scope of the present invention.

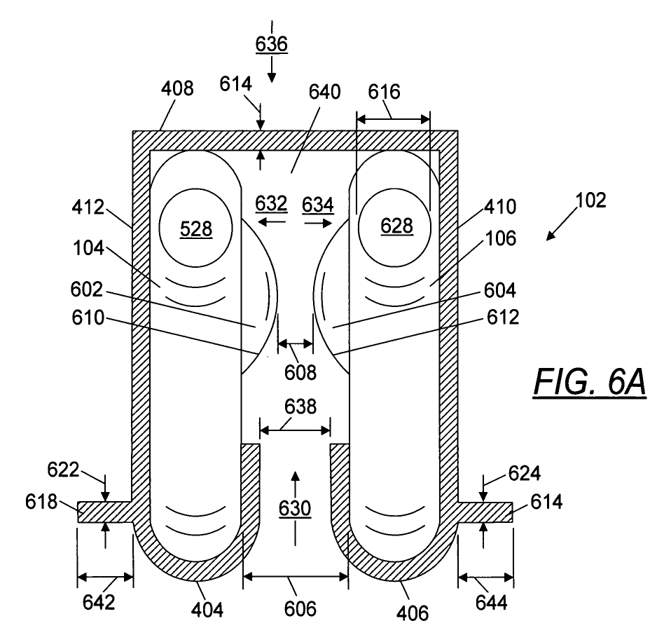

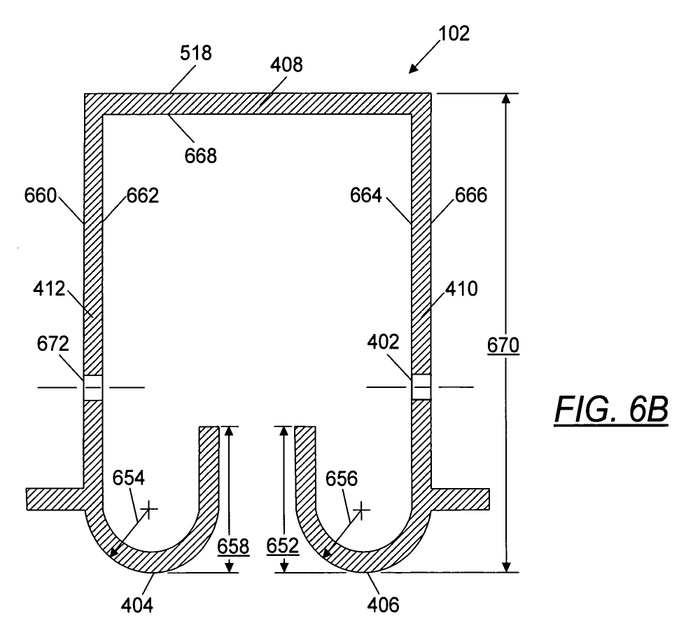

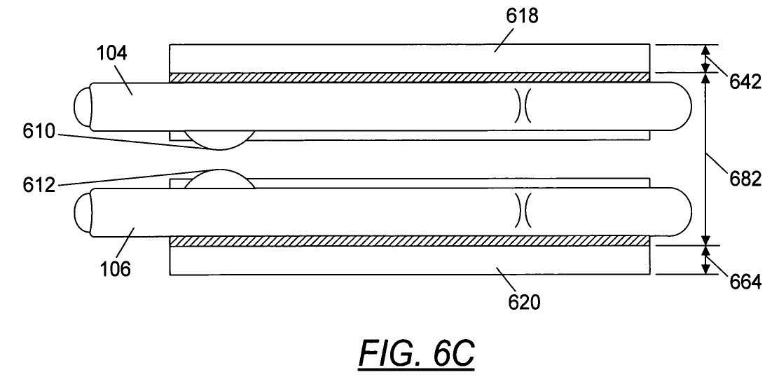

Applicant believes that the means of activating the LED lights is one of the most advantageous and novel features of the present invention. As will be apparent from a review of the drawings, the means of activating the LED lights provides partial protection of the switches for the LED lights from the direct flames encountered during a fire as well as reduced the likelihood of unintentional activation of the switch during storage of a fire helmet with a mounted LED light assembly. The means of activating the LED lights will be more fully described below with reference to FIG. 6A.

As depicted in FIG. 1, LED light assembly 100 is in its engaged position. As used in this specification, engaged position shall mean the configuration that one or more switches are depressed or actuated to cause light from the LED bulbs.

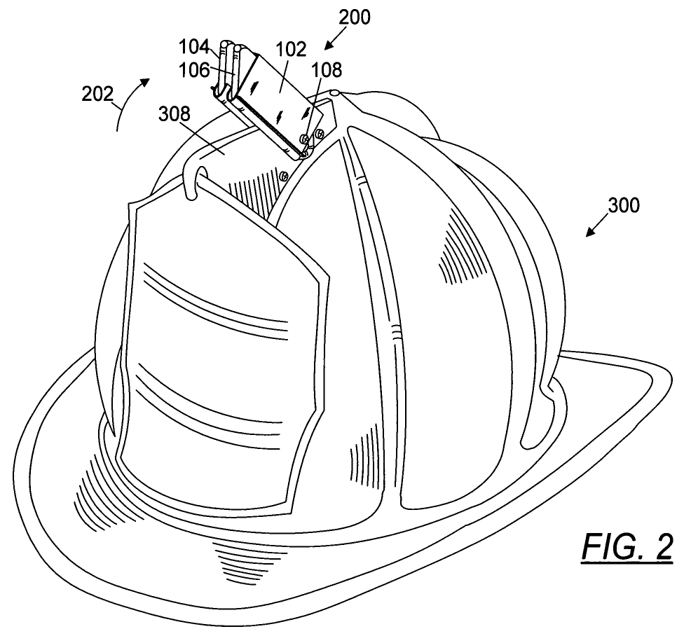

As depicted in FIG. 2, LED light assembly 200 is in its disengaged position. As used in the specification, disengaged position shall mean the configuration that no switch is depressed or actuated and thus no light is emitted from the LED bulbs. In using a LED light assembly, a user applies a force in an upward direction 202 to raise said LED light assembly 200 pivotally about pivotal fastener 108. As will be described more fully with reference to FIG. 6A, brass front piece holder 308 is no longer contacting a switch in this configuration 200.

FIG. 3 depicts a traditional style fire helmet 300. Traditional style fire helmet 300 comprises a dome shaped protective enclosure 302 for a head, a brim 304, a front piece holder 308 and a fire front 312. For convenience in referencing, said traditional style fire helmet 300 comprises proximal side 314, distal side 316, first transverse side 320, opposing transverse side, and a top side 318. Said traditional style fire helmet 300 further comprises a plurality of raised ridges 322 that provide structural support to said dome shaped protective enclosure 302 and/or decorative features to the fire helmet assembly 300. Said plurality of raised ridges 322 are disposed such that they are substantially equally spaced about the exterior of the dome shaped protective enclosure 302 in a hub and spoke conformation, the hub 306 being disposed about the center of top side 318 of the dome shaped protective enclosure 302. At least one raised ridge 324 is disposed along proximal side 314, substantially in the center thereof, from the top side 318 hub 306 to the brim 304.

As depicted in FIG. 3, a front piece holder 308 is removably attached to said raised ridge 324 about the top side 318 of said dome shaped protective enclosure 302. As depicted in FIGS. 1 and 2, said front piece holder 308 is frequently removably attached to said raised ridge 324 by means of screws or screw-bolt assemblies. Front piece holder 308 comprises a shoulder portion 310 in substantially an inverted U-shape that is adapted to secure fire front 312 about proximal side 314 of dome shaped protective enclosure 302.

Front piece holder 308 is commonly formed of brass, but may suitably be formed of other materials that confirm to the safety standards applicable to fire helmets. Front piece holder may comprise decorative elements such as silk screened eagles, Maltese crosses and the like and may even be cast with ornamental design elements such as eagles. A suitable front piece holder that may be used with the present invention is one according to the teachings of U.S. Pat. No. 1,889,537.

As will be apparent, the present invention may be adapted to any style fire helmet. By way of example, Cairns manufactures suitable traditional style fire helmets and front piece holders that are available through Station House Supply d/b/a The Fire Barn at 375 Jaffrey Road, Petersborough, N.H. Suitable traditional style fire helmets are sold as the “N5A New Yorker”, “Cairns 1010 Fiberglass helmets” and “N6A Sam Houston” with item numbers 1010FS, 1010XS, 1010FD, 1010XD, 1010XSB, 1010XDB, N5ABS, N5ABD, N6AFS, N6AFD, N6AGD, N6ABDG. Suitable traditional style fire helmet front piece holders are sold as the “silk-screened eagle” and “silk-screened Maltese cross” with item numbers M9P and M6P. Another suitable traditional fire helmet manufactured by Cairns and sold under the trade name 880 TRADITION is distributed via website at TheFireStore.com. In another embodiment, traditional fire helmet 300 comprises a thermal and impact resistant urethane, Kevlar, Ultem molding compound or fiberglass meeting the NFPA performance standards. In another embodiment, traditional fire helmet 300 comprises a glass filled polymer with high temperature resistance. In another embodiment, traditional fire helmet 300 comprises a material that may be subjected to temperatures of about 275 degrees Fahrenheit for a period of five minutes while retaining the temperature at head form surface from exceeding a temperature of about 109 degrees Fahrenheit.

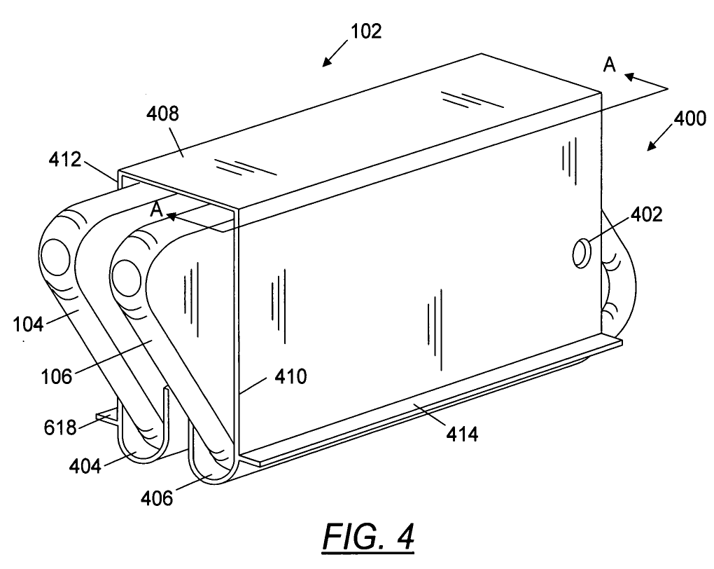

FIG. 4 depicts the LED light assembly 400, substantially the same as LED light assemblies 100 of FIG. 1 and 200 of FIG. 2. Housing 102 comprises a clamping mechanism integrally formed and adapted for pivotal movement so as to compress the first jaw 412 against said front piece holder 308 and/or raised ridge 324 and the second jaw 410, thereby retaining them in the clamping mechanism 102 under spring tension. Clamping mechanism 102 comprises a generally arcuate clamping mechanism 102 in a unitary structure comprising first jaw 412, second jaw 410 and distal wall 408. Housing 102 may be formed of any metal, metal alloy or metallic material suitable high temperature exposure. In one embodiment, housing 102 is formed of brass. In other embodiments, housing 102 is formed of polymeric materials known in the art to withstand extreme temperatures and be safe for this type of application.

Referring again to FIG. 4, first jaw 412 comprises first guide 404 adapted and configured to guide and support at least one LED light 104. Second jaw 410 comprises second guide 406 adapted and configured to guide and support at least one LED light 106. Second jaw 410 further comprises an outwardly protruding second lip 414 adapted and configured to provide a convenient means to raise and lower said LED light assembly when mounted on a fire helmet 300. Similarly, first jaw 412 comprises first lip (see 618 of FIG. 6A). While in use, the user frequently will be wearing safety gloves and unable to operate devices requiring fine motor skills or depression of small buttons. Outwardly protruding lip 414 (and corresponding lip of the first jaw) provides a means of “catching,” that is, a place of contact for the user to apply the upward force 202 (of FIG. 2) necessary to engage and disengage the LED light assembly during use.

As will be apparent to those skilled in the art, a LED light assembly in accordance with the present invention may be configured to house a single LED light or a plurality of LED lights. A preferred embodiment comprises two LED lights, providing a back-up light source in the event of the failure of one LED light source.

As will also be apparent, in alternative embodiments (not depicted) the means of mounting and/or securing a LED light device 104, 106 within housing 102 may additionally or alternatively comprise adhesive, hook and eye fasteners, hook and pile loop fasteners (e.g. VELCRO brand), snap engagement and other means known in the art.

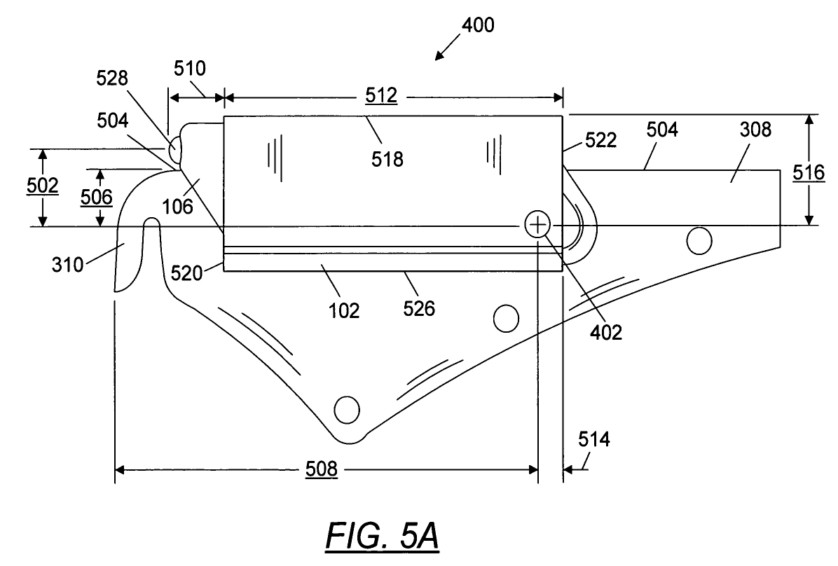

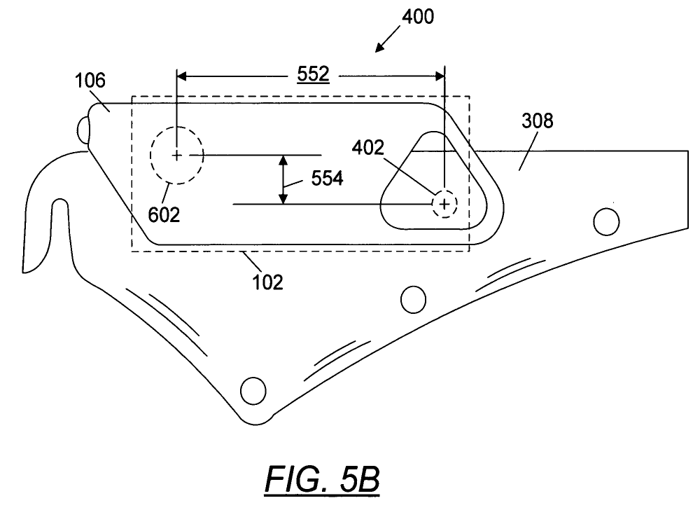

Referring again to FIG. 4, LED light assembly 400 further comprises an aperture 402 adapted and configured to accept a pivotable fastener 108 means for removable mounting. FIG. 5A depicts a side view of LED light assembly 400 mounted on front piece holder 308.

Referring to FIG. 5A and the embodiment depicted, the center point of aperture 402 is disposed a distance 508 of from about 0.5 inches to about 6.5 inches, preferably from about 1.5 to about 3.75 inches, and most preferably about 3 inches, from the furthermost protruding portion of shoulder 310. In one embodiment, the center point of aperture 402 is disposed a distance 514 of from about ¼ inch to about one inch, preferably about ½ inch, from the rearward longitudinal end 522 of housing 102. In one embodiment, the center point of aperture 402 is disposed a distance 516 of from about ½ inch to about 4 inches, preferably about 3 inches, from the upper transverse side of housing 102. In one embodiment, the center point of aperture 402 is disposed a distance 502 of from about 1/32 inch to about 3 inches, preferably from about ⅜ inch to about ½ inch, from the midpoint of LED bulb 528 of LED light device 106. In one embodiment, the center point of aperture 402 is disposed a distance 506 of from about ½ inch to about 1 inch, preferably about ¾ inch, from the uppermost portion 504 of shoulder 310 and front piece holder 308.

Referring again to FIG. 5A and the embodiment depicted, distance 512 of housing 102 comprises from about 2 inches to about 7 inches, preferably from about 2 inches to about 3 inches, and most preferably about 2¾ inches, from the forward longitudinal end 520 to the rearward longitudinal end 522.

Referring again to FIG. 5A and the embodiment depicted, LED light device 106 is disposed about housing 102 such that LED bulb 528 protrudes from forward longitudinal end 520 a distance 510 of from about 1/32 inch to about 1 inch, preferably from about 1/16 to about ½ inch.

FIG. 5B depicts the side view of LED light assembly 400 mounted on front piece holder 308 as in FIG. 5A, except that housing 102 is shown in dashed lines to permit a visual representation of the relationship of LED light device 106 as it is disposed with said housing 102. Referring to FIG. 5B and the embodiment depicted, the center point of a switch 602 is disposed at a distance 554 from the center point of aperture 402, distance 554 comprising from about 1/32 inch to about 2 inches, preferably from about ¼ inch to about 1.5 inches, and most preferably about ½ inch. In one embodiment, the center point of a switch 602 is disposed at a distance 552 from the center point of aperture 402, distance 552 comprising from about 1 inch to about 6 inches, preferably from about 2 inches to about 3 inches, and most preferably about 1⅝ inch.

FIG. 6A depicts the side view of a LED light assembly. LED light device 104 is mounted in housing 102 and secured in place by first guide 404. First guide 404 comprises an inwardly curved lip portion. FIG. 6A depicts how LED light device 104 is inserted and contained in housing 102 such that its bulb 528 is disposed about the portion of LED light assembly aligned with the proximal side 314 of traditional fire helmet 300. Referring to FIG. 6A, said inwardly curved portion of first guide 404 facilitates the insertion of, as wells as supports when mounted, LED light device 104. Similarly, second guide 406 comprises an inwardly curved lip portion that facilitates the insertion of, as wells as supports when mounted, LED light device 106.

As will be apparent from a review of the embodiment of LED light devices 104, 106 in FIGS. 6A, 6C, 7A, 7B and 8, the body of said LED light devices 104, 106 comprises a generally flattened oblong configuration. LED light source, (bulb 628, 528) is mounted such that the LED light is exposed on a front surface of the body. LED preferably comprises a blue, red or white LED, however, other color LEDs may be suitably substituted.

Referring again to FIG. 6A and the embodiment depicted, LED light device 104 comprises switch 602 and LED light device 106 comprises switch 604. When in the disengaged configuration, switches 602 and 604 are disposed at a distance 608 of from about ⅛ inch to about ½ inch, preferably about ¼ inch. In one embodiment, switches 602 and 604 are outwardly protruding from the planar surface of the LED light device housing and substantially arcuate shaped. When in the engaged or disengaged configurations, the planar surfaces of the LED light device housings of 104 and 106 are disposed at a distance 606 of from about 1/32 inch to about one inch, preferably about ⅜ inch to about ½ inch. As will be apparent, distance 606 and distance 608 must be related such that when switch 602, 604 are depressed, bulbs 528, 628 are caused to be lit.

Referring again to FIG. 6A and the embodiment depicted, LED light device 104 comprises bulb 528 and LED light device 106 comprises bulb 628. When in use, the user lowers LED light assembly in the direction of 636. Front piece holder 308 causes a force to be applied in the direction of 630. When front piece holder 308 contacts switch 602 at first contact point 610, it causes switch 602 to be depressed in the direction of 632, actuating a mechanism that closes a circuit and provides the power that causes bulb 528 to light. Similarly, when front piece holder 308 contacts switch 604 at second contact point 612, it causes switch 604 to be depressed in the direction of 634, actuating a mechanism that closes a circuit and provides the power that causes bulb 628 to light. By way of example, an actuator on switch 602, 604 may force contact against a battery or power source, thus making the electrical connection between the battery or power source and LED.

In another embodiment, depression of switches 602 and/or 604 actuates a mechanism that opens a circuit.

By way of another example, switch 602, 604 may comprise a usually-on momentary switch. A force in the direction of 634 and/or 632 on switch 602 and/or 604 until an actuator forces contact against a battery or other power source. In this configuration, the connection is broken as soon as the force is removed.

In another embodiment, LED lights 528, 628 are lit in the disengaged configuration and depression of switches 602 and/or 604 causes bulbs 528 and/or 628 to turn off from said lit state.

As will be apparent from FIG. 6A, distance 638 is greater than distance 608. In one embodiment, distance 638 is from about ⅜ inch to about ½ inch. Distance 638 is sufficient to permit the insertion of front piece holder 308 in channel 640. As will also be apparent, distance 638 is approximately the width of front piece holder 308 in order to ensure a tight fitting and intimate contact between the front piece holder and switches 602 and 604. As will also be apparent, distance 606 comprises distance 608 and twice the distance of 614 (the thickness of housing 102). The clamping mechanism assists in applying the force necessary to depresses switches 602 and 604.

Referring again to FIG. 6A and the embodiment depicted, the means of activating the LED lights (e.g. bulbs) comprises applying a downward force on housing 102 and rotating housing 102 about pivotable fastener 108, thereby causing an upward force from front piece holder 308; simultaneously contacting front piece holder 308 with switch 602 at first contact point 610, depressing switch 602 in the direction of 632 and contacting front piece holder 308 with switch 604 at second contact point 612, depressing switch 604 in the direction of 634.

In the embodiment depicted, front piece holder 308 provides a sufficiently large contact surface such that precision alignment with first contact point 610 and second contact point 612 is not necessary to accurately cause depression of switches 602 and 604. During use in an application where LED light assembly is mounted on a fire helmet, it is foreseeable that a protruding object may be bumped from time to time, especially since it is out of the user's field of view. The sufficiently large contact surface of front piece holder 308 greatly reduces the failure rate of the means of activating the LED lights under these conditions. In one embodiment, front piece holder 308 comprises a left first transverse contact surface of from about 0.5 square inches to about 10 square inches, preferably about 1 square inch. Similarly, front piece holder comprises an opposing transverse contact surface of from about 0.5 square inches to about 10 square inches, preferably about 1 square inch.

Referring again to FIG. 6A, housing 102 comprises outwardly protruding lips 618 and 614. Each lip protrudes a distance 642, 644 of from about ⅛ inch to about one inch, preferably about ¼ inch, and has a thickness 622, 624 of from about of from about 0.01 inch to about 0.1 inch. Although not required, it is preferable that each outwardly protruding lip 614, 618 forms a substantially L-shaped configuration with the exterior walls of first jaw 412 and second jaw 410. In some embodiments (not depicted), outwardly protruding lip 614, 618 does not extend the entire longitudinal length of LED light assembly. It is preferred that, in such embodiments, that such outwardly protruding lip 614, 618 extend at least about 10 per cent of the longitudinal length 512 of LED light assembly.

By way of example, housing 102 may be formed of metal having a thickness that adequately supports the LED light devices in a rigid and flexible formation. Flexibility is desirable for the clamping mechanism to operate efficiently. While the thickness may be varied according to the particular application desired by the user, examples will be provided for applications where the LED light assembly is mounted on a fire helmet. For such application, housing 102 may be formed of a metal with a thickness of from about 0.01 to about 0.1 inches. For applications mounted on a fire helmet, applicant believes brass may be preferable. In one embodiment, housing 102 may preferably be formed of brass or another non-ferrous metal alloy having a thickness of from about 0.0142 to about 0.0253. In one embodiment, housing 102 may preferably be formed of brass or another non-ferrous metal alloy having a density of from about 0.63 to about 1.122 pounds per square foot. In one embodiment, housing 102 may preferably be formed of brass or another non-ferrous metal alloy having a Brown & Sharp gauge measurement of from 22 to about 30.

As will be apparent, said outwardly protruding lips 618, 614 are depicted as small linear protrusions, however, any suitable size and shape may be used in this respect. By way of example, said outwardly protruding lips 618, 614 may be curved inwardly or outwardly to form a cylindrical configuration. Such cylindrical configuration may be a solid structure or tubular structure with a lumen formed therein. In one embodiment, outwardly protruding lips 618, 614 may form a curve with a radius of from about 1 millimeter to about 5 millimeters, preferably from about 2 millimeters to about 4 millimeters. In yet other embodiments, outwardly protruding lip 614, 618 may be substituted with a hook or other protrusion that enables a user to easily engage and disengage LED light assembly when mounted on a fire helmet.

By way of another example, outwardly protruding lips 618, 614 may not extend the full longitudinal distance 512 between forward longitudinal end 520 and rearward longitudinal end 522 (see FIG. 5A).

Referring again to FIG. 6A, housing 102 comprises a thickness 614 of from about 0.01 inch to about 0.1 inch. In one embodiment, thickness 614 is substantially the same as thicknesses 622 and 624. In another embodiment, thickness 614 is less than thicknesses 622 and 624. In yet another embodiment, thickness 614 is greater than thicknesses 622 and 624.

Referring again to FIG. 6A and the embodiment depicted, distal wall 408 comprises a substantially L-shaped juncture with first jaw 412 and second jaw 410. As will be apparent, this juncture may be rounded if desired.

Referring again to FIG. 6A and the embodiment depicted, bulb 628 has a diameter of from about ⅛ inch to about ½ inch, preferably from about ⅛ inch to about 2/8 inch. It is preferred, but not required that bulb 528 is substantially the same size as bulb 628.

FIG. 6B depicts a housing 102 without the LED light devices mounted therein. In one embodiment depicted, clamping mechanism 102 is configured in a generally U-shaped cross section with opposed first jaw 412 portion biased inwardly in close proximity to second jaw 410 portion. First jaw 412 functions to produce sufficient pressure to compress the second jaw 410 containing front piece holder 308 therebetween when in the engaged position. The clamping mechanism assists in applying the forces necessary 632, 634 to depress switches 602, 604.

Referring again to FIG. 6B, first guide 404 comprises a radius 654 of from about 1/32 inch to about ¼ inch. Second guide 406 comprises a radius 656 of from about 1/32 inch to about ¼ inch. It is preferred, but not required, that radius 654 is substantially the same as radius 656. The inwardly curved lip portion of first guide 404 extends a distance 658 of from about 1/32 inch to about 3 inches, preferably about ⅛ inch to about 1.5 inches, and most preferably from about ⅛ inch to about ¼ inch. Similarly, inwardly curved lip portion of second guide 406 extends a distance 652 of from 1/32 inch to about 3 inches, preferably about ⅛ inch to about 1.5 inches, and most preferably from about ⅛ inch to about ¼ inch. It is preferred, but not required, that distance 658 is substantially the same as distance 652.

In the embodiment depicted in FIG. 6B, it is preferred that distance 658 be such that first guide 404 and second guide 406 do not interfere with fastener 108 as it is engaged in apertures 402 and 672. Should first guide 404 and second guide 406 extend further than the central longitudinal axis of fastener 108 as it is engaged in apertures 402 and 672, it will be necessary to create corresponding apertures in first guide 404 and second guide 406 to facilitate a channel for insertion of fastener 108 as it extends between apertures 402 and 672.

Referring again to FIG. 6B and the embodiment depicted, distal wall 408 comprises a first exterior surface 518 and a first interior surface 668. First jaw 412 comprises a second exterior surface 660 and a second interior surface 662. Second jaw 410 comprises a third exterior surface 666 and a third interior surface 664.

Referring again to FIGS. 6A and 6B, at least a portion of LED light device 104 communicates with second interior surface 662 when it is mounted. Similarly, at least a portion of LED light device 106 communicates with third interior surface 664 when it is mounted.

In one embodiment, switch 604 is disposed on LED device 106 such that it is intimately close to third interior surface 664 when it is mounted. There is sufficient distance between the planar surface of LED light device 106 and third interior surface 664 that the switch 604 is not depressed in the disengaged position. When the LED light assembly is engaged, the planar surface of the LED light device 106 communicates with the third interior surface 664, causing switch 604 to be depressed and bulb 628 to be lit. As will be apparent, a similar arrangement and positioning may be used for LED light device 104 and second interior surface 662.

Referring again to FIGS. 6A and 6B, at least apportion of LED light device 104 preferably communicates with first interior surface 668 when it is mounted. Similarly, at least a portion of LED light device 106 communicates with first interior surface 668 when it is mounted. As will be apparent, it is not required that there be communication between first interior surface 668 and LED light device 104 and/or 106. However, such configuration facilitates a compact and minimally protruding design for the user. As will be apparent, it is not required that there be communication between second interior surface 662 and LED light device 104 or communication between third interior surface 664 and LED light device 106. It is preferably, however, that any distance be small enough so as to not interfere with the means of depressing the switches 602, 604 and turning on bulbs 528 and 628.

Referring again to FIG. 6B, aperture 402 of second jaw 410 and corresponding aperture 672 of first jaw 412 are disposed such that insertion of a pivotable fastening means 108 between the two apertures will not encounter interference with first guide 404 or second guide 406. As will be apparent, apertures 672 and 402 are disposed at a distance greater than 652 from the lowermost point of the inwardly curved lips 404, 406.

Referring again to FIG. 6B, housing 102 comprises a depth 670 of from about 1 inch to about 3 inches, preferably from about 1 inch to about 1.5 inches.

Referring again to FIG. 6B, clamping mechanism 102 is integrally formed so that first jaw 412 and second jaw 410 are in pivoting relation to one another. As used in this specification, spring means an elastic, stressed, stored energy element that, when released, will recover its basic form or position. The biasing of first jaw 412 in relation to second jaw 410 creates a spring with sufficient tension to compress first jaw 412 toward second jaw 410 against front piece holder 308, thereby creating the forces necessary to depress the switches 602, 604 and cause the bulbs 528, 628 to light. Applicants believe that the material properties also serve to enhance the spring's tension, simplicity in design, and functionality. More specifically, the resiliency of the metal material allows a user to easily open the clamp by separating first jaw 412 from second jaw 410 with an upward force applied by the fingers, and upon release of the fingers and upward force, the first jaw returns to its resting position, compressing the first jaw 412 in close proximity (distance 638) with second jaw 410. Thus, the spring is simple in design and requires no coils, hinges, fasteners, or other additional mechanical parts.

FIG. 6C depicts a top sectional view along A-A of FIG. 4.

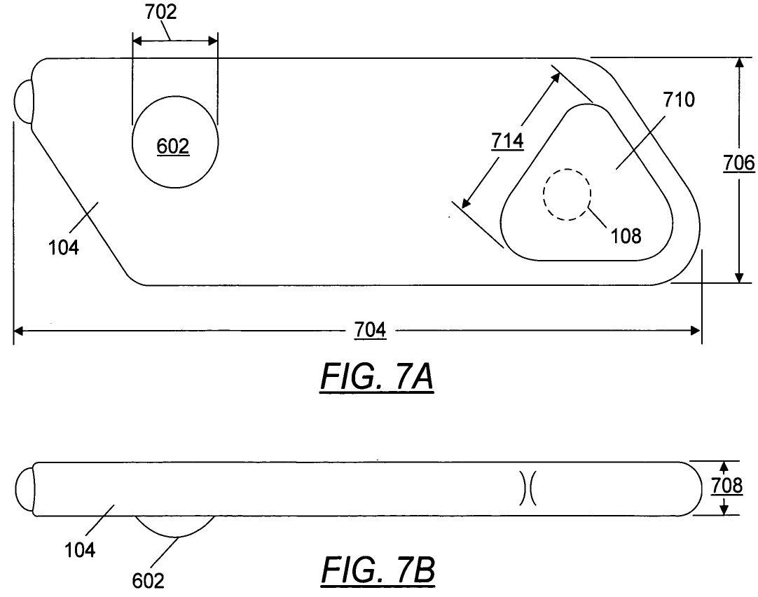

FIG. 7A depicts a side view of one embodiment of a LED light device 104. Preferably, but not necessarily, LED light device 106 is substantially the same as 104. In the embodiment depicted, switch 602 has an arcuate shape with a diameter 702 of from about ⅛ inch to about 2 inches, preferably about ⅜ inch to about ½ inch. In one embodiment, LED light device 104 comprises a length 704 of from about 1 to about 7 inches, preferably from about 1 to about 4 inches, and more preferably from about 2 to about 3 inches. In one embodiment, LED light device 104 comprises a width 706 of from about 0.5 inch to about 3 inches, preferably from about 0.75 to about 1 inch.

FIG. 7B depicts a plan view of one embodiment of a LED light device 104. In one embodiment, LED light device 104 comprises a thickness 708 of from about 1/16 inch to about 1 inch, preferably from about ¼ inch to about ½ inch.

In one embodiment, LED light devices 104 and 106 comprise a wearable LED light sold under the registered trademark and trade name SAPPHIRE and SAPPHIRE CRYSTAL by ASP, Inc., 2511 E. Capitol Dr., Appletone, Wis. 54911 and distributed through a website TheFireStore.com.

In one embodiment, LED light devices 104 and 106 comprise a semi-conductor based LED light. In one embodiment, LED light devices 104 and 106 comprise a plurality of lithium power cells and crystals. In one embodiment, LED light devices 104 and 106 comprise a power source with a battery life of from about 10,000 to about 50,000 hours. In one embodiment, LED light devices 104 and 106 comprise lightweight, thin, flat replaceable batteries. By way of example, but not limitation, CR 2016 batteries may be used. In one embodiment, LED light devices 104 and 106 comprise a switch comprising a computer snap dome. In one embodiment, LED light devices 104 and 106 comprise a low temperature certified power source. In one embodiment, LED light devices 104 and 106 comprise a vibration resistant power source. In one embodiment, LED light devices 104 and 106 comprise a housing formed of an aluminum body and a layer of composite communicating with said aluminum body. In one embodiment, LED light devices 104 and 106 comprise a LED light having a 180 degree viewing radius. In one embodiment, LED light devices 104 and 106 comprise a LED light with a visibility of up to one mile.

In one embodiment, LED light devices 104 and/or 106 comprise a LED light with two operating modes, commonly known in the art as a blinking mode and a steady mode.

In another embodiment, LED light devices 104 and/or 106 comprise a tail light LED. In another embodiment, LED light devices 104 and/or 106 comprise a recoil LED with or without a parabola shaped reflector.

In another embodiment, light devices 104 and/or 106 comprise a housing formed of a material that protects the power source against thermal impact under conditions commonly encountered by firefighters (e.g. protects against thermal impact at temperatures up to about 275 degrees Fahrenheit).

Referring again to FIG. 7A, cutout 710 comprises a void in the housing of LED light device 104. Cutout 710 creates a space for pivotable fastener assembly 108 to be disposed when LED light assembly is mounted for use upon a conventional fire helmet 300. In the embodiment depicted, cutout 710 is substantially triangular shaped with rounded corners. The triangle essentially comprises an isosceles triangle with a side having a length 714 of from about ½ inch to about 1.5 inches, preferably from about ¾ inch to about 1 inch. As will be apparent, many sizes and shapes of cutout 710 are possible to accomplish the desired functionality. By way of another example, a circular or D-ring configuration might be commonly available on commercially available LED light devices.

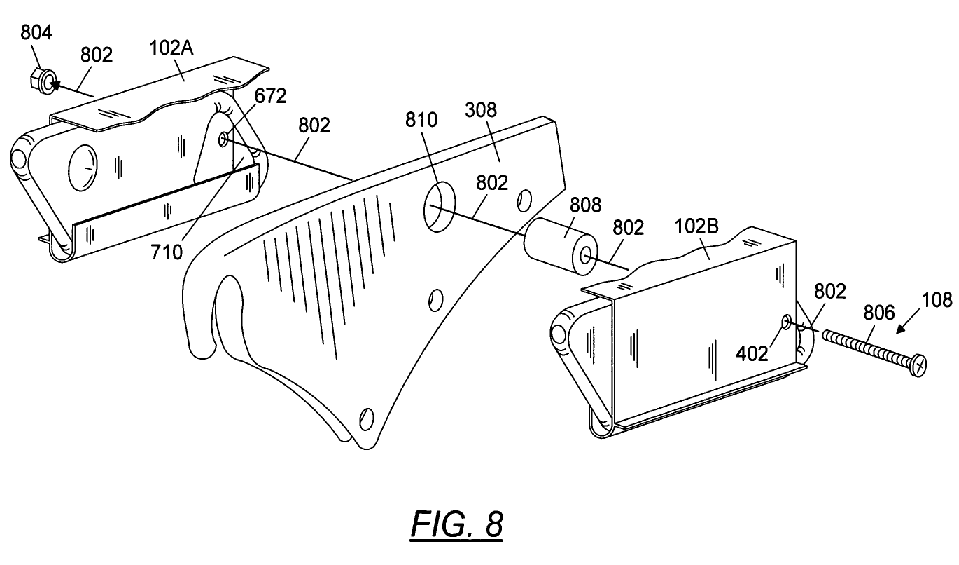

FIG. 8 depicts how LED light assembly is assembled. In the embodiment depicted, pivotable fastener assembly 108 comprises a screw 806, a bolt 804, and a cylindrical spacer 808. In other embodiments (not depicted), pivotal fastener assembly 108 comprises only screw 806 and bolt 804. In other embodiments (not depicted), pivotal fastener assembly 108 comprises a screw 806, a bolt 804, and two or more cylindrical spacers 808. In one embodiment, the spacer is replaced by an integrally formed “bushing” contained within the LED light devices, for example, at cutout 710 of FIG. 8.

In one embodiment, it is preferred that screw 806, bolt 804 and cylindrical spacer 808 are formed of brass. In another embodiment, screw 806, bolt 804 and cylindrical spacer 808 are formed of a metal or metal alloy that is capable of withstanding extremely high temperatures, e.g. those encountered during an inflagration hazard requiring rescue workers and fire fighters to assist (withstand degradation at temperatures of up to about 275 degrees Fahrenheit).

Referring again to FIG. 8 and the embodiment depicted, cylindrical spacer 808 comprises a tubular member optionally and preferably without threads. In another embodiment, cylindrical spacer 808 comprises a tubular member having internal threads mating with the threads of a screw 806 and creating a frictional engagement of said screw 806. To mount the LED light assembly to a front piece holder 308, an aperture 810 is aligned with apertures 402 and 672 of housing 102A and 102B, and cylindrical spacer 808 is disposed within aperture 810 in alignment therebetween, such that a screw 806 may be axially 802 inserted through cylindrical spacer 808 and then threaded through bolt 804 to create a frictional engagement of the screw 806, thus removably securing the LED light assembly to a front piece holder 308. Cylindrical spacer 808 is aligned with and disposed within void 710 of LED light devices 104, 106, thus providing a secondary means of securing said LED light devices 104, 106 within housing 102.

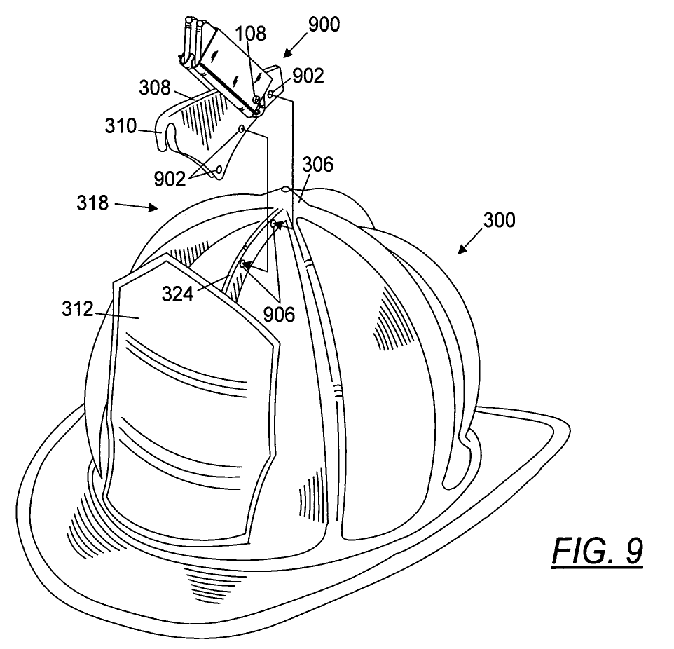

FIG. 9 depicts LED light assembly 900 further comprising front piece holder 308. Front piece holder 308 comprises a plurality of apertures 902 that correspond with apertures 906 of raised ridge 324 for insertion of fasteners and mounting upon conventional fire helmet 300. As will be apparent, LED assembly 900 is substantially the same as previously described with the exception that it additionally includes front piece holder 308. In this embodiment, the LED light assembly is easily mounted on a traditional fire helmet 300 with little or no modification to the existing fire helmet. In some applications, a hole is preferably drilled in raised ridge 324 of traditional fire helmet 300 to provide a channel for the fastener assembly 108.

Referring again to FIGS. 8 and 9 and the embodiment depicted, mounting the LED light assembly that includes a front piece holder 308 may be accomplished by aligning apertures 902 and 906 such that a screw may be axially inserted through said apertures 902, 906 and then threaded through a bolt to create a frictional engagement of the screw, thus removably securing the LED light assembly to a traditional fire helmet 300.

### LED Light Device 104, 106

Preferably, light emitting diodes (“LED”) are used as the light emitting source for LED light devices 104, 106. As well known in the art, LED lights have properties that render them particularly suited to this application. Specifically, in comparison to incandescent bulbs, LED lights use from about 70 to about 90 per cent less power, produce no UV radiation, have reduced heat emissions, are substantially shock resistant, and may last up to 50,000 hours. Thus, it is preferable that in one embodiment, the light emitting source produce no UV radiation.

One feature of LED lights that renders them particularly suited to this application is their light refraction. As known to those skilled in the art, LED lights have less light scattering in the presence of smoke particles.

In one embodiment, it is preferred that the light emitting source comprise one or a plurality of LED lights. Preferably, a blue LED light is used, however, yellow, green and red LED lights may also be suitably used in this application.

In one embodiment, it is preferable that the light emitted be in the blue range of the visible spectrum. In one embodiment, it is preferable that the light emitted comprise a wavelength of from about 400 to about 500 nanometers, preferably from about 420 to about 480 nanometers, and most preferably about 450 nanometers. In another embodiment, it is preferably that the light emitted comprise a frequency of from about 600 to about 700 Terahertz, preferably about 666 Terahertz.

LED lights are well known in the art. One may suitably adapt or construct a LED light of appropriate size and strength for this application.

### Size

As will be apparent, the LED light assembly can be manufactured to any desired size. In order to accommodate the size of most conventional fire helmets 300, preferred embodiments of LED light assembly do not exceed a length of about seven inches. In another embodiments, LED light assembly does not exceed a volume of about sixty five cubic inches, and preferably does not exceed a volume of about 27 cubic inches. The use of a LED light allows for a compact design which applicant believes will be advantageous for applications mounted to fire helmets and safety hats. These preferred embodiments of LED light assembly do not exceed a length of about three inches. In another embodiments, LED light assembly does not exceed a volume of about 12 cubic inches.

As previously described, LED light assembly may also be manufactured in embodiments that are not intended to be worn by a user. As will be apparent, the means of activating the LED light may be suitably used with another contact surface substituted for front piece holder 308. These embodiments may be made in a range of sizes and shapes to accommodate the desired application. They may advantageously incorporate more powerful power supplies and larger light emitting bulbs or a larger plurality of bulbs.

For example, LED light assembly might be sized appropriately for mounting on a vehicle, boat or structure. Such an embodiment might find particular applications assisting a user to locate or identify objects or sites under dark conditions. For example, a LED light assembly might be mounted in the stairwell of a home. During a power failure or fire, the LED could be selectively activated by a pressing force against the housing. Thus, young children, disabled persons or rescue workers could easily operate the LED light assembly and create a light emission to assist in locating the stairwell under dark or smoky conditions.

Similarly, embodiments may be fashioned for utility in outdoor activities to assist in locating vehicles, bathrooms, docks, boats and the like in dark, smoggy or foggy conditions. These embodiments allow simple and selective engagement such that fine motor skills or precision are not necessary for the user. This feature enables disabled people and small children to easily operate the LED light assembly. It may also be advantageously used by a user in low visibility conditions since the user can activate the LED light despite the inability to locate a small switch on the housing. Another advantage of this selective activation mechanism is that the battery life is preserved when the LED light is activated only when desired (as opposed to being continuously activated on a routine cycle (photosensitive switches for example) or perpetually for the life of the battery).

As another example, LED light assembly may be sized appropriately for portable devices and hands-free work applications in dark and/or confined spaces. This portable embodiment would have particular applications for construction workers, mechanics, repair persons, utility workers, mine workers and the like.

### Materials and Methods of Fabrication

LED light assembly may be manufactured as a unitary device comprising all of the essential elements. LED light devices are well known in the art and may be manufactured according to the teachings of U.S. Pat. Nos. 7,001,058, 7,001,056, 7,002,291, 7,001,048, 7,001,035, 6,999,850, 6,998,650, 6,997,591, 6,997,576 and the like. Manufacturing methods for housings of many sizes and configurations, as well as materials appropriate for thermal impact resistance, are well known in the art.

Alternatively, LED light assembly may be assembled from separately manufactured parts or parts that are commercially available. By way of example, an appropriate housing 102 may be manufactured with known manufacturing techniques. Thereafter, commercially available LED light devices may be inserted into said housing.

By way of another example, an appropriate housing 102 may be manufactured with known manufacturing techniques. Thereafter, commercially available LED light devices may be inserted into said housing and the combination may be mounted onto commercially available front piece holders 308.

By way of another example, an appropriate housing 102 and front piece holders 308 may be separately manufactured with known manufacturing techniques. Thereafter, commercially available LED light devices may be inserted into said housing and the combination may be mounted onto commercially available fire helmets.

LED light assembly housing 102 is desirably formed of a metal, metal alloy, a plastic, leather, rubber, synthetic rubber, rubber-like material, synthetic leather, leather-like material, a polymer, or a composite material. It is preferred, but not required, that the material comprise any combination of high temperature resistance and thermally insulative, wear- resistant, anti-static, anti-corrosive and water-repellant properties. By way of example, but not limitation, said LED light assembly housing 102 may be formed of a moldable high strength, resilient impact resistant polymeric or composite material. By way of another example, said LED light assembly housing 102 may be formed of brass.

An optional score line (not shown) may be disposed along the distal wall 408 to impart additional flexibility to the pivoting portion of the clamping mechanism 102.

In one embodiment well suited for applications that will not include exposure to high temperatures, housing 102 is integrally formed as a unitary structure via a single molding process such as injection molding with a thermoplastic material. The housing 102 is molded to predetermined dimensions to permit maximum flexibility and compression of the jaw portion of the clamping mechanism during use.

In another embodiment well suited for applications involving exposure to high temperatures, said housing 102 may be fabricated from a single sheet of flexible, resilient metal, metal alloy, metallic material or other suitable material having a predetermined thickness and hardness in order to simplify the manufacturing process. The form may be cut out or stamped using known manufacturing techniques and then folded to its functional configuration.

In another embodiment, the housing 102 comprises two or more sections cooperatively assembled to the desired configuration. For example, the outwardly curved lip portion of the first guide 404 may be separately manufactured and joined together by known manufacturing methods such as heat welding or adhesion. These sections may be, but it is not required that they be, permanently adhered to one another by means known to one skilled in the art. In yet another embodiment, these sections may be removably and adjustably joined together by means known to one skilled in the art.

I claim:

1. A LED light assembly comprising
a housing adapted to be removably attached to a helmet or protective headgear,
at least one LED light device, wherein
said LED light device comprises a switch, wherein said switch controls said LED light device,
said LED light device is engaged to said housing, and
a means of actuating said switch.

2. The LED light assembly of claim 1, wherein said housing is adapted for pivotable movement about said helmet or protective headgear.

3. The LED light assembly of claim 2, wherein said helmet or protective headgear and switch cooperate to actuate said switch.

4. The LED light assembly of claim 3, wherein said housing is adapted to rotate and cause said switch to contact said helmet or protective headgear thereby actuating said switch.

5. The LED light assembly of claim 1, wherein said housing comprises a unitary structure having a generally arcuate shape and comprising a first jaw, a second jaw, and a distal wall, wherein said first jaw, said second jaw, and said distal wall cooperate to create spring tension between said first jaw and said second jaw.

6. The LED light assembly of claim 5, wherein said first jaw comprises a first guide adapted and configured to guide and support at least one said LED light device.

7. The LED light assembly of claim 6, wherein said second jaw comprises an outwardly protruding second lip.

8. The LED light assembly of claim 7, wherein said second jaw comprises a second guide adapted and configured to guide and support at least one said LED light device.

9. The LED light assembly of claim 1, wherein said LED light device is mountable according to a selected one of a plurality of mounting styles, comprising said LED light device dimensioned to cooperate for forward facing mounting style with said housing.

10. The LED light assembly of claim 1, wherein said LED light device is mountable according to a selected one of a plurality of mounting styles, comprising said LED light device dimensioned to cooperate for rearward facing mounting style with said housing.

11. A LED light assembly comprising
a housing adapted to be removably attached to a front piece holder of a traditional fire helmet,
a first LED light device, wherein
said first LED light device comprises a first switch and a first LED bulb,
said first LED light device is engaged to said housing, and
a means of actuating said first switch thereby causing said first LED bulb to illuminate.

12. The LED light assembly of claim 11, wherein said LED light assembly further comprises a second LED light device, wherein
said second LED light device comprises a second switch and a second LED bulb,
said second LED light device is engaged to said housing, and a means of actuating said second switch thereby causing said second LED bulb to illuminate.

13. The LED light assembly of claim 12, wherein said means of activating and deactivating said first and second LED bulbs comprises a clamping mechanism of said housing, wherein said clamping mechanism is integrally formed and adapted for pivotal movement about said front piece holder of said traditional fire helmet.

14. The LED light assembly of claim 13, wherein said clamping mechanism comprises a generally arcuate shape comprising a first jaw, a second jaw, and a distal wall, wherein said first jaw portion is biased inwardly in close proximity to said second jaw.

15. The LED light assembly of claim 14, wherein said first and said second LED bulbs are activated by said clamping mechanism wherein said first jaw and said second jaw compress against said front piece holder and depress said first and said second switches.

16. A LED light assembly comprising
a housing wherein said housing
is adapted to be removably attached to a helmet or protective headgear,
is adapted for pivotable movement about said helmet or protective headgear by a pivotable fastener assembly,
comprises a first jaw and a second jaw, wherein one of said first jaw or said second jaw comprises a guide adapted and configured to guide and support at least one said LED light device,
at least one LED light device, wherein
comprises at least one outwardly protruding lip, wherein said outwardly protruding lip protrudes from one of said first jaw or said second jaw,
said LED light device comprises a switch, wherein said switch controls said LED light device, and
said LED light device is engaged to said housing, and
a means of actuating said switch.

17. The LED light assembly of claim 16, wherein said housing is adapted to be removably attached to a front piece holder of a traditional fire helmet comprising
a front piece holder,
wherein said LED light device further comprises a LED bulb and a contact point,
wherein when said front piece holder contacts said contact point, it causes said switch to depress and said first LED bulb to illuminate.

18. The LED light assembly of claim 16, wherein said LED light assembly further comprises a plurality of LED light devices.

19. The LED light assembly of claim 16, wherein said housing comprises a nonferrous metal alloy.

20. The LED light assembly of claim 16, wherein said LED light device comprises a LED bulb color selected from the group consisting of white, red or blue.
